(19) United States
(12) Patent Application Publication
(10) Pub. No.: US 2016/0152506 A1
(43) Pub. Date: Jun. 2, 2016

(54) METHOD FOR SEPARATING THIN GLASS

(71) Applicant: SCHOTT AG, Mainz (DE)

(72) Inventors: Matthias JOTZ, Alfeld (DE); Andreas HABECK, Undenheim (DE); Andreas NICKUT, Delligsen (DE)

(73) Assignee: SCHOTT AG, Mainz (DE)

(21) Appl. No.: 14/956,138

(22) Filed: Dec. 1, 2015

(30) Foreign Application Priority Data
Dec. 1, 2014 (DE) 10 2014 117 642.1
May 21, 2015 (DE) 10 2015 108 062.1

(51) Int. Cl. C03B 33/023

(52) U.S. Cl. CPC C03B 33/023; C03B 33/0235

(57) ABSTRACT

A method for processing thin glass is provided. The method includes: providing thin glass having a flat surface and in a form selected from the group consisting of a sheet, plate, ribbon, and film; scoring the flat surface using a mechanical scoring tool to produce one or more scorings that delimit the thin glass into a plurality of thin glass plates and/or delimit one or more edges of the thin glass; applying a blasting liquid to form a moisture film on the thin glass thereby wetting scorings; and heating the moisture film until it evaporates at least partially to cleave the thin glass at the scorings and forming fresh break edges.

### CROSS REFERENCE TO RELATED APPLICATIONS

This application claims the benefit under 35 U.S.C. §119(a) of German Patent Application No. 10 2014 117 642.1 filed Dec. 1, 2014 and German Patent Application No. 10 2015 108 062.1 filed May 21, 2015, the entire content of both of which are incorporated herein by reference.

### BACKGROUND

1. Field of the Invention

The present invention relates to a method for separating thin glass into small thin glass plates or for trimming borders or edges of glass films, glass ribbons, glass plates, or glass sheets, and also relates to thin glass plates equipped with structures produced by such method.

The term “structures” refers to any structure which has been applied to the individual smaller thin glass plates. This includes deposition, etching, coating, roughening, and other processing measures known in microtechnology, and also includes the mounting of components for equipping chips.

In the context of the present application, thin glass refers to plate-shaped or ribbon-shaped or film-like glass with a wall thickness of <1.2 mm, or <1.0 mm, or <0.8 mm, or <0.6 mm, or <350 μm, or <250 μm, or <100 μm, or <50 μm, however, a minimum thickness of 3 μm, or of 10 μm, or of 15 μm is observed. Ultrathin glass (UTG) has a wall thickness of less than 350 μm.

2. Description of Related Art

Thin glasses are used in many fields of technology, for example in displays, in windows for optoelectronic components, in encapsulations of components, and in electrically insulating layers. Small thin glass plates are also suitable as cover glasses for display devices, touch panels, solar cells, semiconductor modules, or LED light sources, and can also be used as part of capacitors, thin film batteries, e.g. thin film storage elements, flexible circuit boards, flexible OLEDs, flexible photovoltaic modules, or e-papers.

However, thin glass is mainly produced as a glass ribbon or glass film of larger surface dimensions than that of small thin glass plates. Therefore, large-area thin glass has to be divided or separated into smaller thin glass plates.

### SUMMARY

The invention is based on the object to provide a method for separating thin glass into small thin glass plates.

According to the invention, thin glass is provided in form of a ribbon or film having a flat surface; the flat surface of the thin glass is scored using a mechanical scoring tool, in order to delimit the thin glass plates against each other; a blasting liquid is applied on the thin glass a as a moisture film in order to wet the produced scorings; and when the individual thin glass plates are needed for further processing, the moisture film is heated until it evaporates at least partially, with the result that the scoring is cleaved and fresh break edges are formed on the thin glass plates singulated in this way.

When thin glass is to be cleaved along scorings, not only scoring depth is of importance, but also “scoring quality”. This “scoring quality”, that means the quality of the edges, which results in a corresponding strength of the edges, is superior in case of mechanical scoring over other processes such as etching or processing with laser radiation. The inventive method produces the best results when a diamond cutting edge is used as a mechanical scoring tool.

In order to cause the scoring to be cleaved, the moisture film simply has to be heated within the scorings. It is therefore advantageous to heat the moisture film only locally, along the produced scorings. This is performed in a way that avoids material stresses, by remaining below the transition temperature T_{g} of the glass.

For heating the scorings, fine flames may be employed, however, it is also possible to direct electromagnetic radiation to the produced scorings.

Since the blasting liquid is only required in the scorings, it may be fed into the respective scoring through a passage that extends within the scoring tool or directly behind the side of the scoring tool on which the scoring has been produced.

For some applications of the small thin glass plates, the break edges should be conserved once they have been produced. The method of the invention offers the possibility to coat the fresh break edges of the thin glass plates with a protective film of a sizing mixture. Such a sizing mixture may contain alcohol substance and wax substance.

It is also possible to produce a kind of coating by flame pyrolysis and to protect the fresh break edges similarly as with a sizing.

As a blasting liquid, pure water may be used. A very suitable blasting liquid is an aqueous liquid including an organic ionic compound. This compound may consist of a cation having a positively charged nitrogen atom and a hydroxyl ion as an anion. Suitable blasting liquids are disclosed in European patent EP 1 726 635 B1, for example.

However, there are also applications in which the thin glass is used as a substrate for structures which are located on the intended small thin glass plates like islands and which have to be protected against water. As an example, lithium polymer layers in batteries can be mentioned, which must not be exposed to water. Therefore, when thin glass is covered with lithium layers and the thin glass is to be divided into small thin glass plates, a non-reactive blasting liquid has to be chosen which has the property of wetting the thin glass and evaporating when being heated and thereby blasting off the thin glass plates. For example, pure alcohol (ethanol) has found to be well suited in this case.

According to a further embodiment of the invention, the thin glass has a fire-polished surface and furthermore preferably exhibits a thickness variation in a range between less than 24 μm and less than 5 μm.

### DESCRIPTION OF DRAWINGS

The invention will now be explained with reference to schematic drawings, wherein:

FIG. 1 shows a sheet of thin glass while scorings are produced;

FIG. 2 shows the application of a moisture film onto the scored thin glass;

FIG. 3 shows the heating of the liquid film applied on the thin glass and the bursting into small thin glass plates;

FIG. 4 is a sectional view through a portion of a thin glass sheet having structures on prepared small thin glass plates during the cleaving of the scorings; and

FIG. 5 shows a scoring head with a scoring tool and feed of blasting liquid.

### DETAILED DESCRIPTION

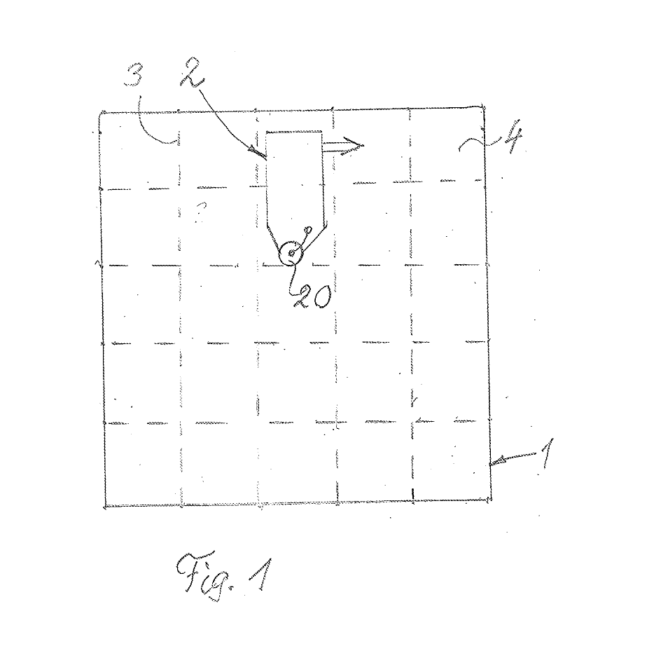

Referring to FIG. 1, a thin glass sheet 1 is schematically shown, together with a scoring head 2 with a scoring tool 20 that is producing scorings 3. In reality the scoring head 2 with scoring tool 20 would, of course, be placed vertically on thin glass sheet 1. Scorings 3 are intended to form a grid defining marks for division of thin glass sheet 1 into individual thin glass plates 4. Once the scorings have been produced, the thin glass 1 is prepared for being separated into small thin glass plates 4.

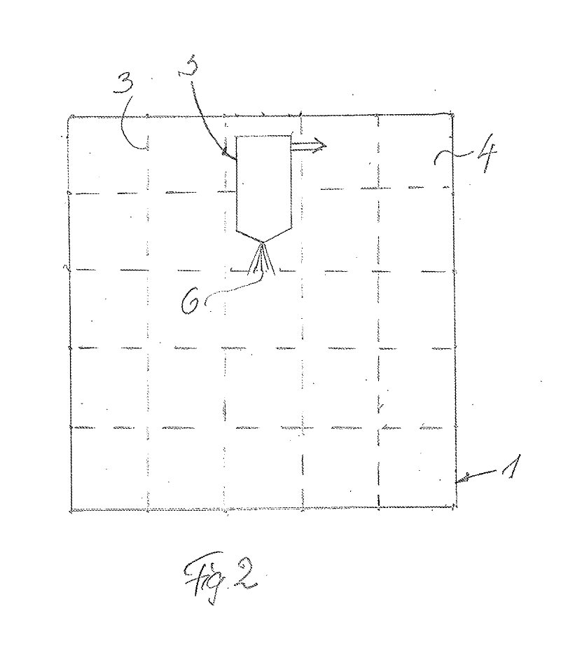

FIG. 2 schematically illustrates the application of a blasting liquid 6 to form a moisture film. For this purpose, a spray head 5 is provided, which is displaceable along scorings 3 and emits blasting liquid 6 onto the scorings. Blasting liquid 6 has the property of wetting the glass and therefore will be drawn into the scorings 3 as a result of capillary action.

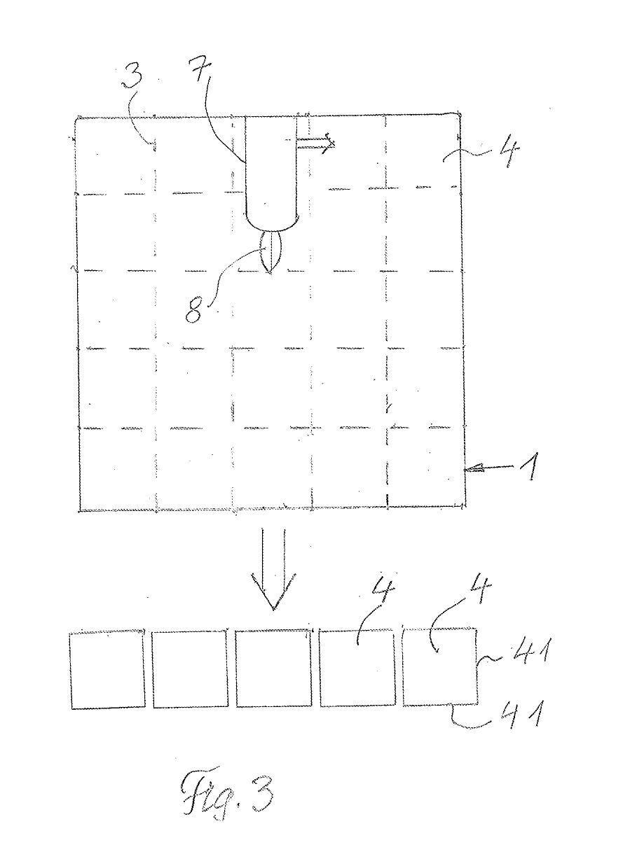

FIG. 3 schematically illustrates the separation process of the small thin glass plates 4. A burner head 7 emits a fine flame 8 whose tip is directed along the scorings 3 to locally heat the thin glass 1 there and to cause the blasting liquid 6 to evaporate. Here, heating is always performed in a manner so that in the heated region the temperature of the glass remains below the transition temperature T_{g} of the glass. In addition, due to thermal expansion local internal stresses and deformations are induced in the region of scorings 3. The resulting disruptive power in scorings 3 divides the thin glass sheet 1 into individual smaller thin glass plates 4, which is schematically illustrated in the lower half of the figure.

The method may as well be applied for severing borders or trimming edges of glass films, glass ribbons, glass plates, or glass sheets.

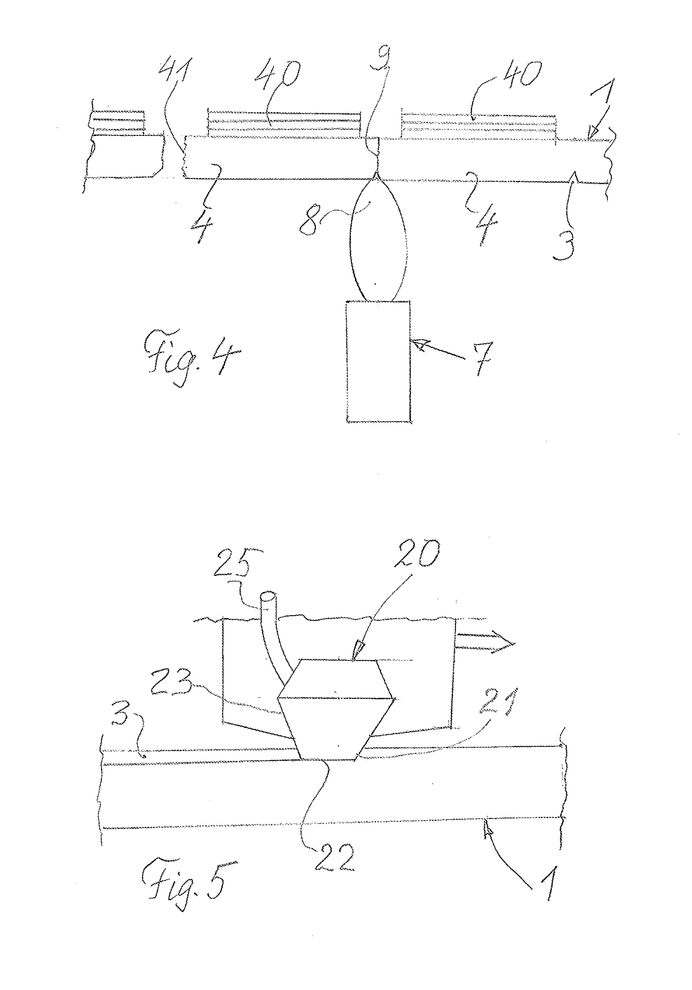

FIG. 4 illustrates the separating of thin glass 1 in the case of sensitive structures 40 on the individual thin glass plates 4. The thin glass 1 has been wetted with a blasting liquid 6, at least in the region of scorings 3, which blasting liquid does not react with the structures 40. Now, when the blasting liquid 6 evaporates within scorings 3 by the impact of heat from flame 8, a disruptive effect will be caused and cracks 9 will be produced in the thin glass 1 propagating along a respective scoring 3, and the cracks 9 will extend through the thin glass 1 and lead to a separation into the individual thin glass plates 4. Thereby, fresh break edges 41 are produced on the thin glass.

FIG. 5 schematically shows how scorings 3 are produced in the thin glass 1. Scoring head 2 comprises mechanical scoring tool 20 in form of a cut diamond that has a front bow cutting edge 21, a lower bottom cutting edge 22, and a rear side 23. A passage 25 extends to the rear side 23 and feeds blasting liquid into the scoring 3 which is thereby wetted with blasting liquid.

While the schematic drawings indicate a single scoring head and a single burner head, a plurality of assemblies will be provided in practice to simultaneously produce and cleave a plurality of scorings.

When the thin glass 1 is separated, as shown in FIG. 3, individual thin glass plates 4 are produced which are bounded by fresh break edges 41. In conjunction with the present invention it is possible to conserve these fresh break edges 41, that means to coat them with a protective film of a sizing mixture. Suitable sizing mixtures are known and include alcohol and wax, for example.

With alcohol substance and wax substance it is moreover possible to produce a sizing mixture which may serve as a blasting liquid as well. Accordingly, if sizing mixture is spray-deposited as the blasting liquid 6, as shown in FIG. 2, the alcohol substance will behave as a wetting agent and as a disruptive power generating agent when heated according to FIG. 3 or 4. Due to the impact of heat, the wax substance will melt and coat the fresh break edges 41 of the thin glass plates 4 with a protective wax layer.

As an alternative to heating the moisture film using fine flames it is also possible to direct electromagnetic radiation to the scorings 3 defining the grid pattern, to separate the equipped thin glass plates.

If structures 40 do not react with water and are resistant, water or the aqueous solution with an organic ionic compound mentioned above may be used as well as a blasting liquid, especially since the latter penetrates into the scorings 3 in the thin glass 1 particularly easily and develops a large disruptive effect.

What is claimed is:

1. A method for processing thin glass, comprising the steps of:
providing thin glass having a flat surface and in a form selected from the group consisting of a sheet, plate, ribbon, and film;
scoring the flat surface using a mechanical scoring tool to produce one or more scorings that delimit the thin glass into a plurality of thin glass plates and/or delimit one or more edges of the thin glass;
applying a blasting liquid to form a moisture film on the thin glass thereby wetting scorings; and
heating the moisture film until it evaporates at least partially to cleave the thin glass at the scorings and forming fresh break edges.

2. The method as claimed in claim 1, wherein the step of using the mechanical scoring tool comprises using diamond cutting edges.

3. The method as claimed in claim 1, wherein the step of heating the moisture film comprises heating, only locally, along the scorings.

4. The method as claimed in claim 1, wherein the step of heating comprises directing fine flames to the scorings.

5. The method as claimed in claim 1, wherein the step of heating comprises directing electromagnetic radiation to the scorings.

6. The method as claimed in claim 1, wherein the step of applying the blasting liquid comprises feeding the blasting liquid through a passage into the scorings.

7. The method as claimed in claim 1, further comprising coating the fresh break edges with a protective film of a sizing mixture.

8. The method as claimed in claim 7, wherein the sizing mixture includes an alcohol substance and/or a wax substance.

9. The method as claimed in claim 1, wherein the blasting liquid does not react with structures applied on the thin glass.

10. The method as claimed in claim 1, wherein the blasting liquid comprises an aqueous liquid including an organic ionic compound.

11. The method as claimed in claim 1, further comprising including a structure that includes thin film storage elements on the thin glass.

12. The method as claimed in claim 1, wherein the step of providing thin glass comprises providing thin glass that has a fire-polished surface and a thickness variation in a range between <24 μm and <5 μm.
